(19) United States
(12) Patent Application Publication
(10) Pub. No.: US 2025/0367686 A1
(43) Pub. Date: Dec. 4, 2025

(54) PAINTING SYSTEM NOZZLE INCLUDING A MAGNET

(71) Applicant: NISSAN NORTH AMERICA, INC., Franklin, TN (US)

(72) Inventors: Sandeep PATIL, Farmington Hills, MI (US); Mohammed Hussain ABDUL JABBAR, Farmington Hills, MI (US)

(21) Appl. No.: 18/732,168

(22) Filed: Jun. 3, 2024

(51) Int. Cl. B05B 5/043; B05B 5/053

(52) U.S. Cl. CPC B05B 5/043; B05B 5/0533

(57) ABSTRACT

A nozzle for a painting system includes a first electrode, a second electrode, a first magnet and a second magnet. The first magnet is disposed between the first electrode and the second electrode when viewed in a direction parallel to a longitudinal axis of the nozzle. The second magnet is disposed between the first electrode and the second electrode when viewed in the direction parallel to the longitudinal axis of the nozzle. The first and second electrodes and the first and second magnets define a passage through which paint is configured to flow.

### BACKGROUND

### Technical Field

The present disclosure generally relates to a nozzle for a painting system. More specifically, the present disclosure relates to a nozzle for a voltage-assisted painting system for applying paint to a vehicle body in which the nozzle includes a magnet.

### Background Information

Applying high viscosity paint is difficult with existing automotive paint systems. The higher the viscosity of the paint to be applied, the larger the force required to apply the paint.

### SUMMARY

An object of the present disclosure is to provide a nozzle for a painting system that facilitates dispensing a high viscosity paint.

In view of the state of the known technology, one aspect of the present disclosure is to provide a nozzle for a painting system including a first electrode, a second electrode, a first magnet and a second magnet. The first magnet is disposed between the first electrode and the second electrode when viewed in a direction parallel to a longitudinal axis of the nozzle. The second magnet is disposed between the first electrode and the second electrode when viewed in the direction parallel to the longitudinal axis of the nozzle. The first and second electrodes and the first and second magnets define a passage through which paint is configured to flow.

Another aspect of the present disclosure is to provide a voltage-assisted painting system including a housing, a power source, and a nozzle. The housing has a conduit configured to receive paint from an external source. The nozzle is disposed in the housing. The nozzle has an inlet that is fluidly connected to the conduit and is configured to receive paint from the conduit. The nozzle has an outlet configured to dispense the paint. The nozzle includes a first electrode, a second electrode, a first magnet, and a second magnet. The first electrode is connected to the power source. The second electrode is connected to the power source. The first magnet is disposed between the first electrode and the second electrode when viewed in a direction parallel to a longitudinal axis of the nozzle. The second magnet is disposed between the first electrode and the second electrode when viewed in the direction parallel to the longitudinal axis of the nozzle. The first and second electrodes and the first and second magnets define a passage through which the paint is configured to flow.

Also other objects, features, aspects and advantages of the disclosed painting system nozzle assembly including a magnet will become apparent to those skilled in the art from the following detailed description, which, taken in conjunction with the annexed drawings, discloses exemplary embodiments of the painting system nozzle assembly including a magnet.

### BRIEF DESCRIPTION OF THE DRAWINGS

Referring now to the attached drawings which form a part of this original disclosure:

FIG. 1 is a perspective view of a housing for a painting system in accordance with an exemplary embodiment;

FIG. 2 is a perspective view of an underside of the housing of FIG. 1;

FIG. 3 is a cross sectional view of the housing of FIGS. 1 and 2;

FIG. 4 is a cross sectional view of a nozzle of the painting system of FIG. 1;

FIG. 5 is a perspective view in cross section of the nozzle of FIG. 4;

FIG. 6 is a top plan view of the nozzle of FIG. 4;

FIG. 7 is a perspective view of a nozzle in accordance with another exemplary embodiment;

FIG. 8 is a perspective view of a nozzle in accordance with another exemplary embodiment;

FIG. 9 is a perspective view of a nozzle in accordance with another exemplary embodiment;

FIG. 10 is a perspective view of a nozzle in accordance with another exemplary embodiment;

FIG. 11 is a perspective view of a nozzle in accordance with another exemplary embodiment;

FIG. 12 is a top plan view of the nozzle of FIG. 11; and

FIG. 13 is a cross sectional view of a nozzle of the painting system of FIG. 1 in which air is supplied to a nozzle outlet.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

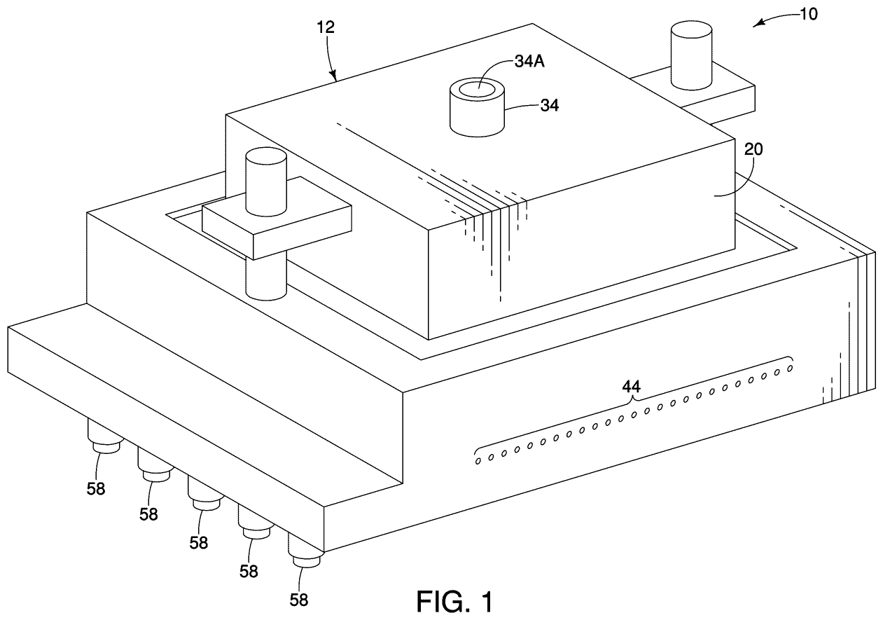

Referring initially to FIGS. 1-4, a voltage-assisted painting system 10 is illustrated in accordance with an exemplary embodiment. The voltage-assisted painting system 10 of the illustrated embodiment can be utilized for applying paint 16 to various types of substrates, such as a vehicle body 18. The voltage-assisted painting system 10 includes a housing 12 and at least one nozzle 14. The housing 12 preferably houses a plurality of nozzles 14. In the illustrated embodiment, the voltage-assisted painting system 10 is illustrated as a multi-nozzle painting system. However, it will be apparent to those skilled in the vehicle field from this disclosure that the voltage-assisted painting system 10 can be utilized as a single nozzle painting system.

In the illustrated embodiment, the term paint refers to any material including, but not limited to, one or more of the following substances: traditional paint, ink, polymers, water, solvents, and other fluids imparting color to a substrate and mixtures of the above-mentioned substances. Paint can also refer to material(s) having viscosities significantly higher and significantly lower than traditional paint viscosities.

The voltage-assisted painting system 10 of the illustrated embodiment uses a magnetohydrodynamic force to facilitate dispensing a fluid, such as a high viscosity or viscoelastic fluid, such as paint. In particular, the voltage-assisted painting system 10 utilizes a nozzle 14 including at least one electrode 20 and at least one magnet 22 to create the magnetohydrodynamic force.

A voltage regulator 24 of the voltage-assisted painting system 10 is electrically connected to each of the electrodes 20 of each nozzle 14 to regulate voltage or electric current to the electrodes 20. The voltage-assisted painting system 10 can comprise one or more voltage regulators 24 that are connected to the nozzles 14 to deliver and regulate electric current or voltage to the electrodes 20. The voltage regulators 24 are illustrated as being connected to some of the nozzles 14 schematically for simplicity.

The electrodes 20 of the illustrated embodiment can be one or more solid electric conductors that are capable of carrying out an electric current or an electric field to the contents of the nozzles 14. The electrodes 20 are preferably made of good electric conducting materials, such as copper and its derivatives, such as a carbon nanotube. As will be described, in the illustrated embodiment, the electrodes 20 are provided as part of the nozzles 14.

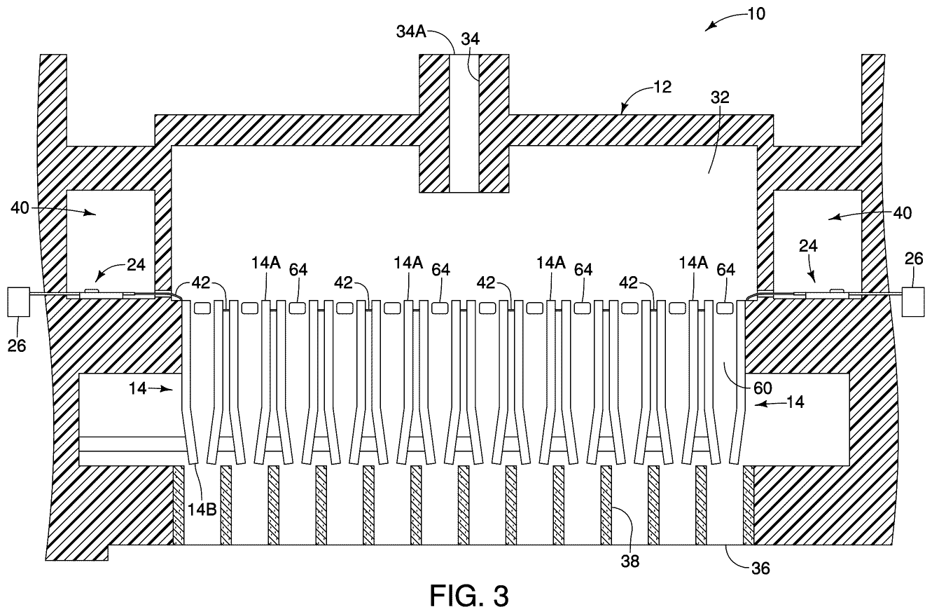

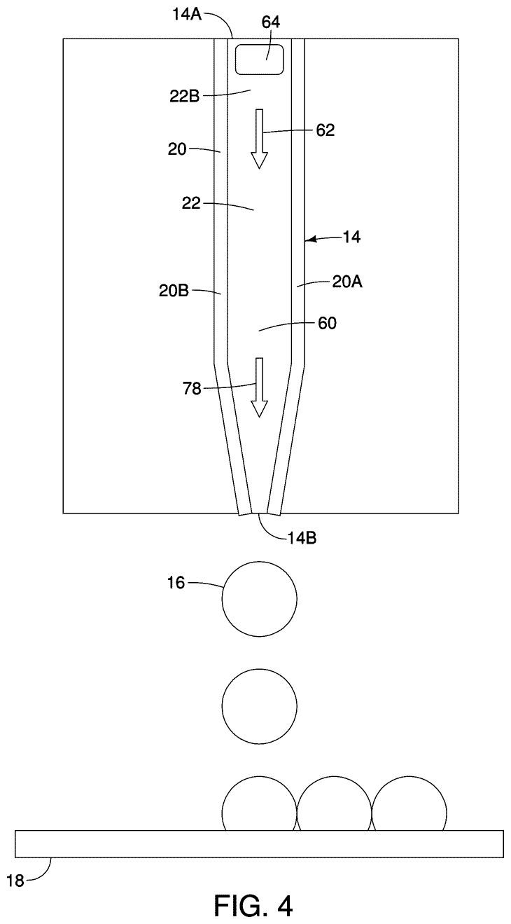

As shown in FIG. 3, the voltage-assisted painting system 10 includes one or more voltage regulators 24 housed in the housing 12. As shown, the housing 12 includes a plurality of voltage regulators 24. In other words, the voltage-assisted painting system 10 of FIGS. 1 to 3 includes the plurality of nozzles 14 and can include one or more plurality of voltage regulators 24 each supplying electric current or voltage to the electrodes 20. The voltage-assisted painting system 10 is provided for paint application to a vehicle body 18 (FIG. 4) using assistance from the voltage regulators 24, the electrodes 20 and the magnets 22. The housing 12 is preferably made of an electric insulating material, such as ceramic.

As the voltage regulators 24 are identical, only one of the voltage regulators 24 will be further described herein. The voltage regulator 24 can include a circuit that creates and maintains a fixed output voltage. The voltage regulator 24 is connected to a power supply 26 that can be internally provided to the housing 12 or can be external to the housing 12. The applied voltage from the voltage regulator 24 produces an electrical potential difference over two electrodes 20 of the nozzle assembly 14.

The voltage-assisted painting system 10 can further utilize a series of air flow channels to apply gas to the droplets at the nozzles 14. Therefore, the voltage-assisted painting system 10 can utilize a combination of magnetohydrodynamic force and air flow application to facilitate droplet formation, as will be further described below. The voltage-assisted painting system 10 preferably applies argon (Ar), helium (He) or nitrogen (N₂) gas to the droplets that are formed at the nozzles 14 to help pull or discharge the droplets from the nozzles 14 by providing further momentum to the droplets, as will be further described below. Preferably, the application of air from the air flow channels also helps spray the formed droplets such that the housing 12 can act as a spray chamber.

Referring to FIG. 3, the housing 12 includes a reservoir 32 for storing paint. The housing 12 includes a conduit 34 that fluidly receives paint from an external source (not shown) to be stored in the reservoir 32. The conduit 34 fluidly connects the reservoir 32 with the external source to supply paint to the reservoir 32 in the housing 12. The conduit 34 includes an opening that defines an inlet 34A that can be considered an inlet for the housing 12. While the housing 12 is illustrated as being provided with the reservoir 32 therein, it will be apparent to those skilled in the vehicle field from this disclosure that the housing 12 can be modified such that the conduit 34 connects directly to the nozzles 14. That is, it will be apparent to those skilled in the vehicle field from this disclosure that the housing 12 does not need to include the reservoir 32. Rather, a reservoir can be provided separately from the housing 12 to deliver paint into the housing 12. Therefore, it will be apparent to those skilled in the vehicle field from this disclosure that the voltage-assisted painting system 10 can include a reservoir that is separately provided from the housing 12.

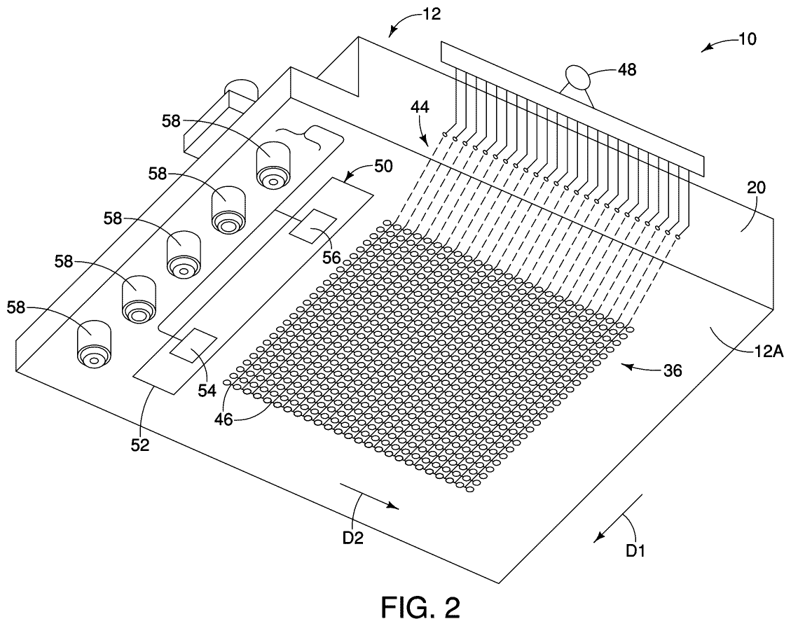

As shown in FIG. 2, the housing 12 includes a plurality of outlets 36 positioned at an underside surface that is opposite side on the housing 12 with respect to the conduit 34. The paint is dispensed from the outlets 36 to be applied to the vehicle body. In the illustrated embodiment, each of the outlets 36 of the housing 12 corresponds to one of the nozzles 14. That is, the outlets 34 of the housing 12 receive paint from the nozzles 14 to dispense, as will be further described. While the housing 12 is illustrated as including a single conduit 34 it will be apparent to those skilled in the vehicle field from this disclosure that the housing 12 can include a plurality of conduits 34 for receiving different colors and/or types of paint. Additionally, while the housing 12 is illustrated as including a single reservoir 32 that is fluidly connected to all of the nozzles 14, it will be apparent to those skilled in the vehicle field from this disclosure that the housing 12 can include a plurality of reservoirs 32 for storing different colors and/or types of paint.

As shown in FIG. 3, the reservoir 32 is a space that receives paint from the conduit 34. The reservoir 32 is preferably is small feedstock reservoir that does not add significant weight to the housing 12. Thus, the reservoir 32 is configured to continuously receive paint from the conduit 34 during use of the voltage-assisted painting system 10. The reservoir 32 includes a plurality openings 32A that extend into the nozzles 14. The housing 12 can further includes a plurality of channels 38 that receive paint from the nozzle assemblies 14. The channels 38 include the outlets 36 of the housing 12 that open to the exterior. Therefore, the channels 38 are fluidly connected to the nozzles 14 to receive paint from the reservoir 32.

Thus, the nozzles 14 are fluidly connected to the reservoir 32 and the outlets 36 of the housing 12. That is, the nozzle assemblies 14 fluidly connect the reservoir 32 with the outlets 36 of the housing 12 to dispense the paint. As shown in FIG. 3, each of the nozzles 14 has an inlet 14A and an outlet 14B. The inlets 14A of the nozzles 14 are fluidly connected to the conduit 34 to receive paint. Each of the outlets 14B of the nozzles 14 dispenses paint into respective ones of the channels 38 that lead to the outlets 36 of the housing 12. Therefore, each of the nozzles 14 has an outlet 14B that dispenses paint. It will be apparent to those skilled in the vehicle field from this disclosure that the housing 12 can be reconfigured without the channels 38. Therefore, the outlets 14B of the nozzles 14 can alternatively extend directly to the exterior of the housing 12.

As shown in FIG. 3, the nozzles 14 are shaped as tubes having a substantially constant volume along a majority of the longitudinal length of the nozzle 14. The nozzles 14 preferably taper towards the outlets 14B so to decrease the volume of the nozzle assemblies 14 near the outlets 14B to the formation of small droplets at the nozzle assemblies 14 and increase the frequency of droplet formation. Alternatively, the nozzles 14 can have a substantially constant volume along the entire length thereof.

As shown in FIG. 3, the housing 12 further includes a chamber 40 that houses the voltage regulators 24. In other words, the voltage regulators 24 are disposed in the chamber 40. The chamber 40 is positioned between the reservoir 32 and the channels 38. Therefore, the voltage regulators 24 are positioned between the reservoir 32 and the channels 38. The outlets 14B of the nozzles 14 are disposed in the channels 38.

In the illustrated embodiment, a direction of paint flow flows from the conduit 34, to the reservoir 32, to the nozzles 14, to the channels 38, and to the outlets 36. That is, the reservoir 32 is upstream of the nozzles 14 and the nozzles 14 are upstream of the outlets 36. In the illustrated embodiment, the chamber(s) 40 that houses the voltage regulator(s) 24 are disposed downstream of the reservoir 32 and upstream of the outlets 36 of the housing 12. As shown in FIG. 3, the chamber 40 is upstream of the outlets 14B of the nozzles 14. That is, the voltage regulators 24 are preferably upstream of the outlets 14B of the nozzles 14.

As shown in FIG. 3, each of the plurality of nozzles 14 of the illustrated embodiment are in electric communication with each other. In particular, the nozzles 14 are electrically connected together via electrical conductors 42. The voltage regulators 24 are electrically connected to one of the nozzles 14 so that the electrical charge or voltage provided to the nozzle 14 can be transmitted through all of the nozzles 14 via the electrical conductors 42. The voltage regulators 24 can be connected to the electrodes 20 of the nozzle assembly 14 via one or more electrical conductors 42. Alternatively, each nozzle 14 can be separately connected to a voltage regulator to individually control the electrical charge or voltage supplied to the nozzle 14.

As shown in FIG. 2, the housing 12 includes a first airflow channel 44 and a second airflow channel 46. The first airflow channel 44 extends through the channels 38 in a first direction D1 to enable external air to flow through the channels 38 in the first direction D1. The second airflow channel 46 extends through the channels 38 in a second direction D2 that is transverse to the first direction D1 to enable external air to flow in the second direction D2. The first and second airflow channels 44 and 46 are arranged and configured to generate air flow forces to help detach the droplets from the outlets 14B of the nozzle assemblies 14. In particular, air flow forces can be directed towards the droplets. Alternatively, air flow can enter the channels 38 tangentially from the first airflow channel 44 to create a swirling moment at the droplets that have been detached from the outlets 14B.

The first airflow channel 44 opens to the exterior of the housing 12, as shown in FIGS. 1 and 2. The voltage-assisted painting system 10 further includes an external airflow source, such as an air pump 48. The air pump 48 is in direct communication with the first airflow channel 44 to pump air from the exterior of the housing 12 into the first airflow channel 44. The first and second airflow channels 44 and 46 are in communication with each other such that air flows from the first airflow channel 44 to the second airflow channel 46.

The second airflow channels 46 intersect with the channels 38 of the housing 12 to enable airflow from the second airflow channels 46 to the channels 38. The second airflow channels 46 intersect with the channels 38 at a location in the vicinity of the outlets 14B of the nozzle assemblies 14 so that air from the second airflow channels 46 is applied to the droplets dispensed from the outlets 14B of the nozzle assemblies 14.

In the illustrated embodiment, air flow forces flow from the air pump 48, to the first airflow channels 44, to the second airflow channels 46, and to the channels 38. In this way, air is pumped from the exterior to the channels 38 to apply airflow forces that will help push the droplets that have been detached from the outlets 14B downward into the channels 38. Therefore, the air flows through the first and second airflow channels 44 and 46 to apply airflow force to the nozzles 14.

As shown in FIGS. 2 and 3, the nozzles 14 are arranged in an array of successive rows and columns within the housing 12. Each of the nozzles 14 preferably has the same size and dimension with respect to each other to ensure uniformity of the droplets that are formed. The inlets 14A of the nozzles 14 have any suitable diameter, such as approximately 250 micros (μm) in diameter. The droplets formed at the outlets 14B of the nozzles 14 have any suitable size, such as a size between 50 μm to 100 μm.

As shown in FIG. 2, the voltage-assisted painting system 10 of the illustrated embodiment can include a control system 50 programmed to control the components of the housing 12, such as the nozzles 14 and the voltage regulators 24. The control system 50 can include an electronic controller 52 for controlling the nozzles 14 and voltage regulators 24, either in combination or selectively as will be described below. The electronic controller 52 is preferably a microcomputer that includes one or more processor(s) 54 and one or computer memory device(s) 56.

The electronic controller 52 can control the voltage regulators 24 to apply voltage to the nozzles 14 as the paint is traveling down the bodies of the nozzles 14. The electronic controller 52 can also control the voltage regulators 24 to adjust the voltage level that is applied to the electrodes 20.

The control system 50 can include memory 56, such as any computer storage device or any computer readable medium with the sole exception of a transitory, propagating signal. For example, the memory 56 can be nonvolatile memory and volatile memory, and can includes a ROM (Read Only Memory) device, a RAM (Random Access Memory) device, a hard disk, a flash drive, etc. The storage device can be any a non-transitory computer readable medium such as a ROM (Read Only Memory) device, a RAM device, a hard disk, a flash drive, etc. The memory 56 is configured to store settings, programs, data, calculations and/or results of the processor(s) 54.

The electronic controller 52 can be programmed to control the sequence, frequency and/or the voltage level emitted by the voltage regulators 24. For example, the electronic controller 52 can be programmed to modulate the electrodes 20 to change the oscillation (e.g. frequency, phase and/or amplitude) of the voltage emitted by the voltage regulators 24.

The housing 12 can include one or more detector(s) (not shown) disposed at the nozzle assemblies 14 or in the vicinity of the nozzles 14 to detect the presence and size of droplets forming at the outlets 14B of the nozzles 14. The detectors can be any type of sensor as needed and/or appropriate. For example, the detector(s) can utilize thermal imaging or acoustic imaging to measure a size or profile of the droplets. The detectors can be equipped with wireless communication devices to send detection signals to the electronic controller 52. The memory 56 of the electronic controller 52 can store parameters for the frequencies emitted by the electrodes 20. The memory 56 can be programmed to set these parameters or programmed to pre-store these parameters.

As shown in FIGS. 1 and 2, the voltage-assisted painting system 10 can further include an inspection system for quality insurance of the paint application. For example, the inspection includes one or more detectors, such as cameras 58, for detecting the paint that is dispensed from the outlets 36 of the housing 12. As shown, the cameras 58 are preferably disposed on a bottom side of the housing 12 in the vicinity of the outlets 36 of the housing 12. The cameras 58 can utilize thermal imaging or acoustic imaging to measure a size or profile of the droplets that are ejected from the outlets 36 of the housing 12. The cameras 58 are in electronic communication with the electronic controller 52 via wired or wireless communication device(s). The electronic controller 52 can be programmed to measure a thickness or uniformity of the paint that is applied to the vehicle body based on the information detected by the cameras 58.

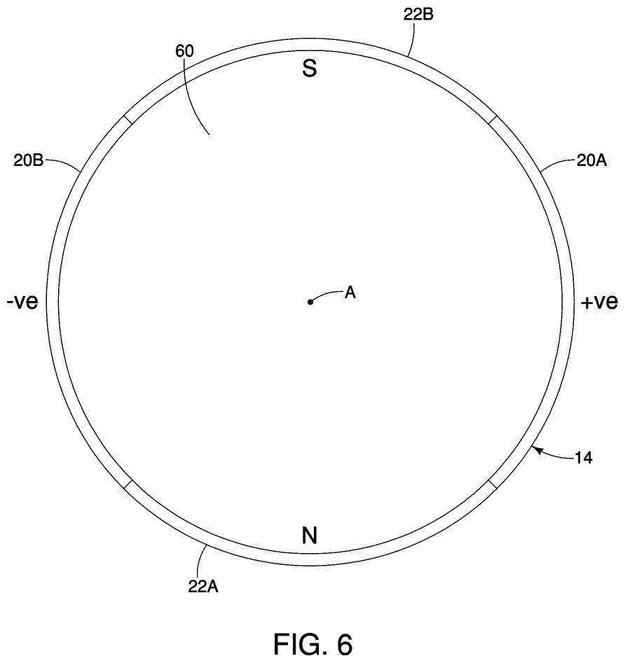

As shown in FIGS. 3, 4 and 6-9, each nozzle 14 includes at least one electrode 20 and at least one magnet 22. Preferably, each nozzle 14 includes a first electrode 20A and a second electrode 20B, and a first magnet 22A and a second magnet 22B. The first and second electrodes 20A and 20B are connected to the power source 26, through the voltage regulators 24, as shown in FIG. 3. The first electrode 20A is preferably a positive electrode. The second electrode 20B is preferably a negative electrode. The first electrode 20A, the second electrode 20B, the first magnet 22A and the second magnet 22B define a passage 60 through which paint is configured to flow. In other words, the passage 60 of each nozzle 14 is in fluid communication with the reservoir 32 and the conduit 34 to receive paint. The paint flow direction 78, as shown in FIG. 4, is from the nozzle inlet 14A to the nozzle outlet 14B.

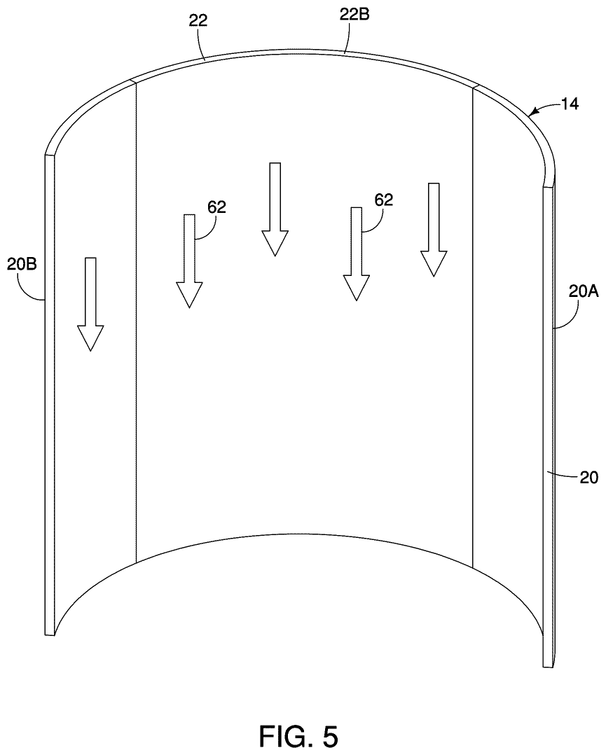

As shown in FIGS. 4-6, the first magnet 22A is disposed between the first electrode 20A and the second electrode 20B when viewed in a direction parallel to a longitudinal axis A of the nozzle 14. The second magnet 22B is disposed between the first electrode 20A and the second electrode 20B when viewed in a direction parallel to the longitudinal axis A of the nozzle 14. The first and second electrodes 20A and 20B are preferably diametrically opposed. The first and second magnets 22A and 22B are preferably diametrically opposed. Each of the first and second magnets extends substantially longitudinally from the nozzle inlet 14A to the nozzle outlet 14B. A circumferential length of each of the first and second electrodes 20A and 20B and the first and second magnets 22A and 22B is preferably substantially equal. The longitudinal lengths of each of the first and second electrodes 20A and 20B and the first and second magnets 22A and 22B is preferably substantially equal. The magnets 22 are made of any suitable material, such as a strong ferrite or ceramic magnet.

The nozzle 14 can taper toward the nozzle outlet 14B such that a diameter of the nozzle outlet 14B is smaller than a diameter of the nozzle inlet 14A. Alternatively, the nozzle 14 can have a substantially constant diameter along the longitudinal length thereof, such that a diameter of the nozzle outlet 14B is substantially equal to a diameter of the nozzle inlet 14A.

Supplying power to the first and second electrodes 20A and 20B generates an electric field. The first and second magnets 22A and 22B generate a magnetic field directed toward the nozzle outlet 14B. In other words, the generated electric field is perpendicular to the generated magnetic field. When electric current passes through the paint in the nozzle passage 60 in the presence of the magnetic field, a propelling force 62 (i.e., a Lorentz force) is applied to the paint. The generated magnetic field propels the paint ions in the paint flow direction 78 toward the nozzle outlet 14B to facilitate dispensing of high viscous and viscoelastic fluid, such as paint, from the nozzle 14. The propelling force 62 applied to the paint is substantially linear, such that substantially no rotational force is applied to the paint in the nozzle passage 60. Ions can be added to the paint to control the conductivity of the paint to control the propelling force applied to the paint. The supply of power to the electrodes 20 can be controlled to control the generated magnetic field to control the flow of the paint through the passage 60.

A transducer 64 is disposed adjacent to the nozzle 14, as shown in FIG. 4. The transducer 64 is configured to emit an acoustic wave to the passage 60. In particular, the transducer 64 is configured emit acoustic forces (e.g., soundwaves) to increase the velocity and kinetic energy of the paint in the passage 60. A transducer can also be disposed adjacent a nozzle outlet 14B to apply pressure to help detach paint bubbles from the nozzle outlet 14B to facilitate forming droplets 16 that can be uniformly and smoothly applied to the surface 18 to be painted.

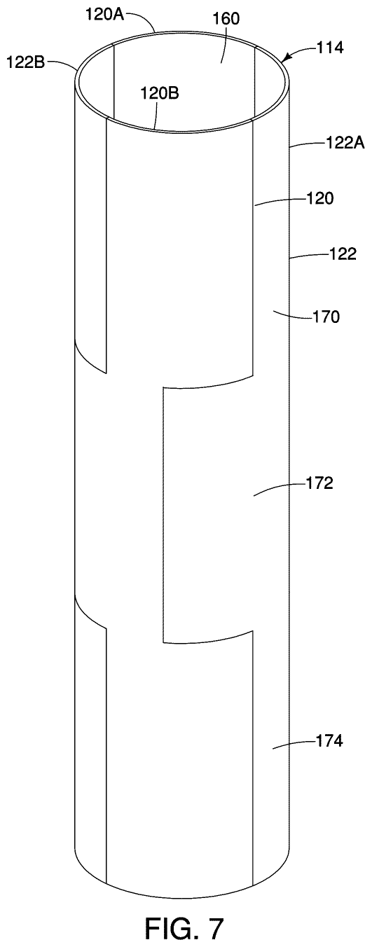

As shown in FIG. 7, a nozzle 114 in accordance with another illustrated exemplary embodiment of the present invention is substantially similar to the nozzle 14 of the voltage-assisted painting system 10 of the exemplary embodiment illustrated in FIGS. 1-6 except for the differences described below. Similar parts are identified with similar reference numerals, except increased by 100 (i.e., 1xx, accordingly).

The nozzle 114 includes a first electrode 120A, a second electrode 120B, a first magnet 122A and a second magnet 122B define a passage 160 through which paint is configured to flow, as shown in FIG. 7. The first magnet 122A includes a first portion 170, a second portion 172 and a third portion 174. The first portion 170 and the third portion 174 are longitudinally aligned. The second portion 172 is circumferentially offset from the first portion 170 and the third portion 174. In other words, the left and right edges of the second portion 172 are not aligned with the left and right edges of the first and third portions 170 and 174. The left and right edges of the first and third portions 170 and 174 are aligned. The second electrode 120B, and the first and second electrodes 120A and 120B are similarly formed.

The nozzle 114 can have a substantially constant diameter along the length thereof, as shown in FIG. 7. Alternatively, the nozzle 114 can have a tapered portion including magnets and electrodes that are not circumferentially offset. Alternatively, the nozzle 114 can have a tapered portion made of any suitable material.

Offsetting a portion of the first and second magnets 122A and 122B adds a rotational component to the propelling force to facilitate movement of the paint through the nozzle passage 160 and to facilitate the formation of droplets at the nozzle outlet. The rotational component adds instability to the paint flowing through the nozzle. The instability growth takes time in stretching and makes drops in fluid length. In other words, the rotational flow provides time for the fluid to stretch and to grow in instability to facilitate forming droplets in the paint at the nozzle outlet.

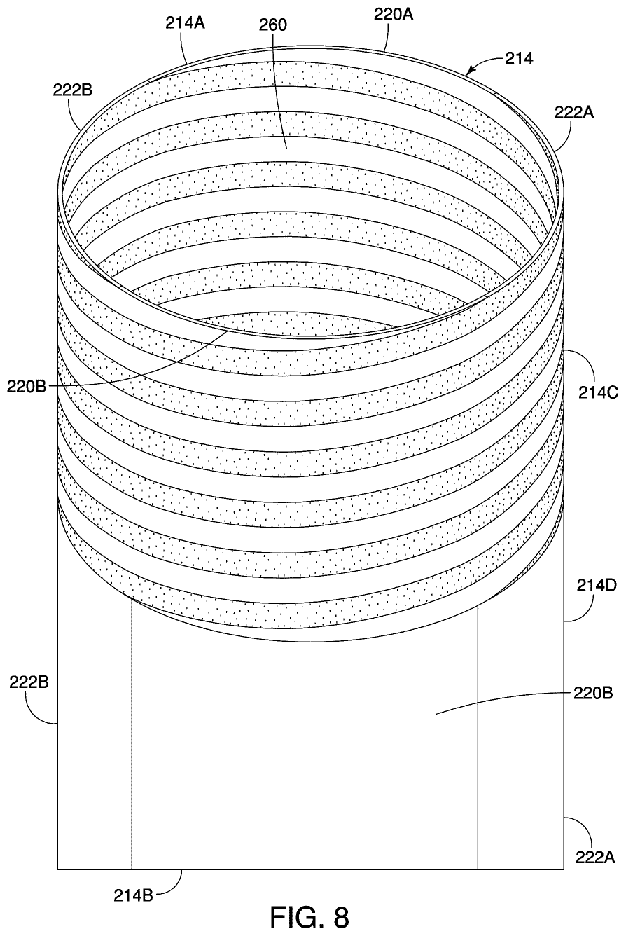

As shown in FIG. 8, a nozzle 214 in accordance with another illustrated exemplary embodiment of the present invention is substantially similar to the nozzle 14 of the voltage-assisted painting system 10 of the exemplary embodiment illustrated in FIGS. 1-6 except for the differences described below. Similar parts are identified with similar reference numerals, except increased by 200 (i.e., 2xx, accordingly).

The nozzle 214 includes a first electrode 220A, a second electrode 220B, a first magnet 222A and a second magnet 222B defining a passage 260 through which paint is configured to flow, as shown in FIG. 8. The nozzle 214 includes a first portion 214C in which each of the first electrode 220A, the second electrode 220B, the first magnet 222A and the second magnet 222B extend substantially helically. The nozzle includes a first portion 214A in which each of the first electrode 220A, the second electrode 220B, the first magnet 222A and the second magnet 222B extend substantially helically. The nozzle 214 includes a second portion 214D in which each of the first electrode 220A, the second electrode 220B, the first magnet 222A and the second magnet 222B extends substantially longitudinally.

The first portion 214C of the nozzle 214 is preferably disposed upstream of the second portion 214D. The first portion 214C of the nozzle 214 is disposed nearer to the nozzle inlet 214A than the second portion 214D. In other words, the helical magnets are disposed at the nozzle inlet 214A, and the longitudinal magnets are disposed at the nozzle outlet 214B. The transition from the first portion 214C of the nozzle 214 to the second portion 214D can be any suitable position along the longitudinal length of the nozzle 214. The helical first portion 214C of the nozzle generates both a rotational component and a linear component to the force applied to the paint. The longitudinal second portion 214D applies a substantially linear force in the longitudinal direction of the nozzle 214. The rotational component adds instability to the paint flowing through the nozzle. The instability growth takes time in stretching and makes drops in fluid length. In other words, the rotational flow provides time for the fluid to stretch and to grow in instability to facilitate forming droplets in the paint at the nozzle outlet.

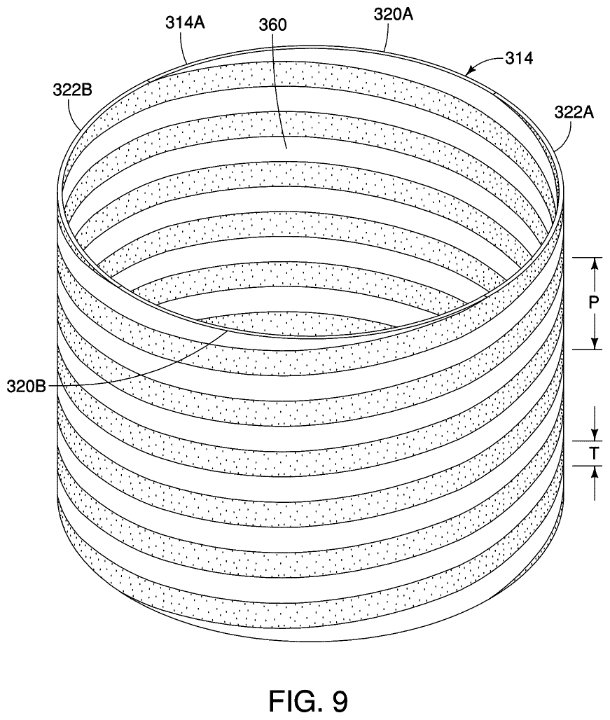

As shown in FIG. 9, a nozzle 314 in accordance with another illustrated exemplary embodiment of the present invention is substantially similar to the nozzle 14 of the voltage-assisted painting system 10 of the exemplary embodiment illustrated in FIGS. 1-6 except for the differences described below. Similar parts are identified with similar reference numerals, except increased by 300 (i.e., 3xx, accordingly).

The nozzle 314 includes a first electrode 320A, a second electrode 320B, a first magnet 322A and a second magnet 322B defining a passage 360 through which paint is configured to flow, as shown in FIG. 9. The first electrode 320A, the second electrode 320B, the first magnet 322A and the second magnet 322B extend substantially helically from the nozzle inlet 314A to the nozzle outlet 314B. Each of the first electrode 320A, the second electrode 320B, the first magnet 322A and the second magnet 322B has a substantially constant pitch from a first end to a second end. In other words, each of the first electrode 320A, the second electrode 320B, the first magnet 322A and the second magnet 322B has a substantially constant pitch P from the nozzle inlet 314A to the nozzle outlet 314B. A longitudinal thickness T of each of the first electrode 320A, the second electrode 320B, the first magnet 322A and the second magnet 322B is substantially constant pitch from the nozzle inlet 314A to the nozzle outlet 314B.

The helical configuration of the nozzle 314 adds a rotational component to the linear force applied to the paint along the entirety of the passage 360 of the nozzle 314. The rotational component adds instability to the paint flowing through the nozzle. The instability growth takes time in stretching and makes drops in fluid length. In other words, the rotational flow provides time for the fluid to stretch and to grow in instability to facilitate forming droplets in the paint at the nozzle outlet.

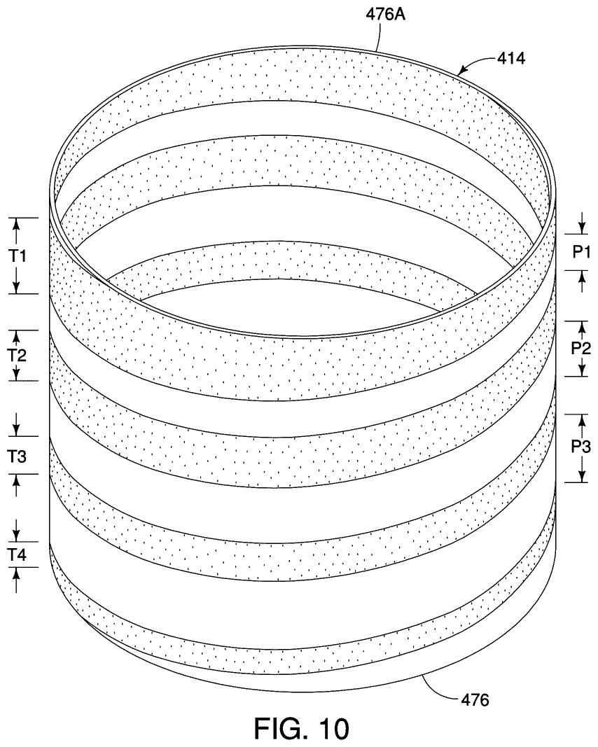

As shown in FIG. 10, a nozzle component in accordance with another illustrated exemplary embodiment of the present invention is substantially similar to the nozzle component of the voltage-assisted painting system of the exemplary embodiment illustrated in FIG. 9 except for the differences described below. Similar parts are identified with similar reference numerals, except increased by 100 (i.e., 4xx, accordingly).

Each of the first electrode, the second electrode, the first magnet and the second magnet (i.e., the nozzle components) has a variable pitch from a first end to a second end, as shown in FIG. 10. An exemplary helical component 476 is illustrated in FIG. 10, and each of the first electrode, the second electrode, the first magnet and the second magnet is similarly configured.

The component 476 extends helically from a first end 476A to a second end 476B, as shown in FIG. 10. The first end 476A is configured to be disposed at a nozzle inlet (314A, FIG. 9) and the second end 476B is configured to be disposed at a nozzle outlet (314B, FIG. 9). The pitch of the component 476 varies from the first end 476A to the second end 476B. As shown in FIG. 10, a first pitch P1 of the component 476 is smaller than a second pitch P2 of the component 476, which is smaller than a third pitch P3 of the component 476. The pitch increases from the first end 476A to the second end 476B of the component.

A longitudinal thickness of the component 476 varies from the first end 476A to the second end 476B, as shown in FIG. 10. The longitudinal thickness decreases from the first end 476A to the second end 476B. The first longitudinal thickness T1 is larger than a second longitudinal thickness T2, which is larger than a third longitudinal thickness T3, which is larger than a fourth longitudinal thickness T4.

Although FIG. 10 illustrates the component 476 having a varying pitch and a varying longitudinal thickness, a component can have a varying pitch and a substantially constant longitudinal thickness, or have a varying longitudinal thickness with a substantially constant pitch.

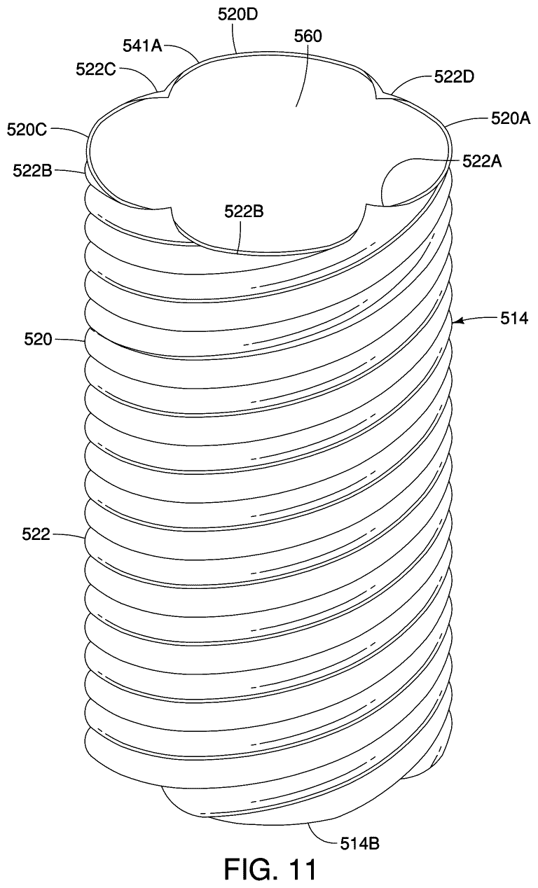

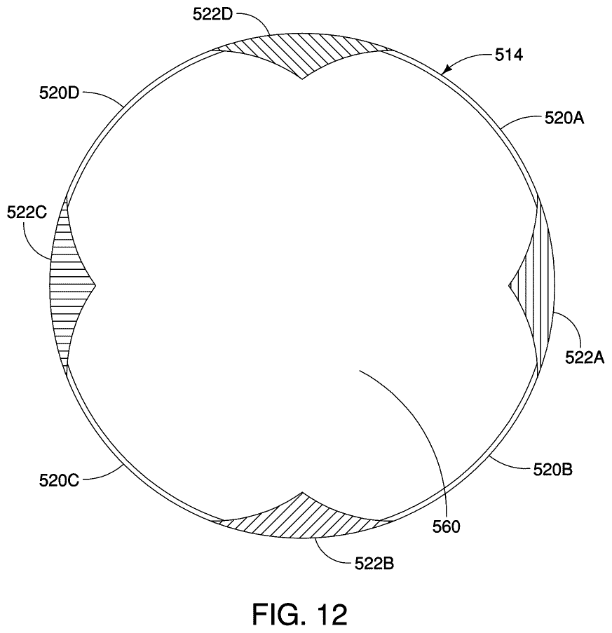

As shown in FIGS. 11-12, a nozzle 514 in accordance with another illustrated exemplary embodiment of the present invention is substantially similar to the nozzle 14 of the voltage-assisted painting system 10 of the exemplary embodiment illustrated in FIGS. 1-6 except for the differences described below. Similar parts are identified with similar reference numerals, except increased by 400 (i.e., 4xx, accordingly).

The nozzle 514 of FIGS. 11-12 includes four electrodes 520 and four magnets 522 that define a passage 560. The nozzle 514 includes a first electrode 520A, a second electrode 520B, a third electrode 520C, a fourth electrode 520D, a first magnet 522A, a second magnet 522B, a third magnet 522c, and a fourth magnet 522D defining the passage 560 through which paint is configured to flow, as shown in FIGS. 11-12. Each of the electrodes 520 and the magnets 522 extends substantially helically from the nozzle inlet 514A to the nozzle outlet 514B. Each of the electrodes 520 and each of the magnets 522 preferably has a substantially constant pitch and a substantially constant longitudinal thickness from a first end to a second end as shown in FIG. 9. Alternatively, each of the electrodes 520 and each of the magnets 522 can have a variable pitch and/or a variable longitudinal thickness as shown in FIG. 10.

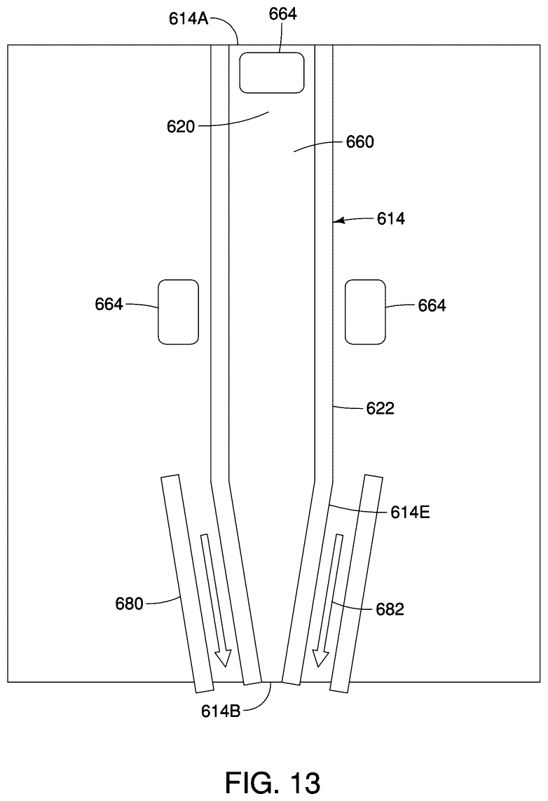

As shown in FIG. 13, a nozzle 614 in accordance with another illustrated exemplary embodiment of the present invention is substantially similar to the nozzle 14 of the voltage-assisted painting system 10 of the exemplary embodiment illustrated in FIGS. 1-6 except for the differences described below. Similar parts are identified with similar reference numerals, except increased by 500 (i.e., 5xx, accordingly).

An air passage 680 surrounds an outer surface 614E of the nozzle 614 at the nozzle outlet 614B, as shown in FIG. 13. The air passage 680 is configured to supply air 682 externally of the nozzle outlet 614B. The supplied air 682 adds instability to the dispensed paint to facilitate the formation of droplets (16, FIG. 4). The supply of air can be pulsed to further add instability to facilitate the formation of droplets.

A plurality of transducers 664 are disposed adjacent to the nozzle 614, as shown in FIG. 13. The transducers 664 are configured to emit acoustic waves to the passage 660. In particular, the transducers 664 are configured emit acoustic forces (e.g., soundwaves) to increase the velocity and kinetic energy of the paint in the passage 660. A transducer can also be disposed adjacent the nozzle outlet 614B to apply pressure to help detach paint bubbles from the nozzle outlet 614B to facilitate forming droplets that can be uniformly and smoothly applied to the surface (18, FIG. 4) to be painted.

In particular, the first and second transducers 16 and 17 of the acoustic force assisted painting system 10 are configured emit acoustic forces (e.g., soundwaves) to increase the velocity and kinetic energy of the paint droplet 31. The increased velocity and kinetic energy of the paint droplet 31 facilitates painting a surface that is oriented in a vertical direction (FIGS. 7 and 8) and facilitates evaporating solvent in the paint droplet 31 to dry the paint droplet 31. The soundwaves emitted by the first and second transducers 16 and 18 also apply pressure to help detach paint bubbles from the outlets 14B of the nozzles 14 to form droplets 31 that can be uniformly and smoothly applied. In the illustrated embodiment, the acoustic force assisted painting system 10 also utilizes electrostatic/magnetic forces, acoustic forces and air flow forces to help detach the droplets from the nozzles 14. In particular, the nozzles 14 are preferably made of a material capable of conducting electrostatic/magnetic forces that will amplify the effect of the acoustic forces generated by the first and second transducers 16 and 17. The housing 12 further includes airflow channels that generate air flow forces that help direct the droplets from the outlets 14B of the nozzles 14 into the paint channels 28, as will be described below.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the voltage-assisted painting system. Accordingly, these terms, as utilized to describe the present invention should be interpreted relative to a vehicle equipped with the voltage-assisted painting system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A nozzle for a painting system, the nozzle comprising:
a first electrode;
a second electrode;
a first magnet disposed between the first and second electrodes when viewed in a direction parallel to a longitudinal axis of the nozzle; and
a second magnet disposed between the first and second electrodes when viewed in the direction parallel to the longitudinal axis of the nozzle,
the first and second electrodes and the first and second magnets defining a passage through which paint is configured to flow.

2. The nozzle for the painting system according to claim 1, wherein
each of the first and second magnets extends substantially longitudinally from a nozzle inlet to a nozzle outlet.

3. The nozzle for the painting system according to claim 2, wherein
each of the first and second magnets includes a first portion, a second portion and a third portion, the first and third portions being longitudinally aligned, the second portion being circumferentially offset from the first and third portions.

4. The nozzle for the painting system according to claim 1, wherein
each of the first and second magnets extends helically from a nozzle inlet to a nozzle outlet.

5. The nozzle for the painting system according to claim 4, wherein
each of the first and second magnets has a substantially constant pitch from a first end to a second end.

6. The nozzle for the painting system according to claim 4, wherein
each of the first and second magnets has a variable pitch from a first end to a second end.

7. The nozzle for the painting system according to claim 6, wherein
the pitch increases from the first end to the second end.

8. The nozzle for the painting system according to claim 4, wherein
a longitudinal thickness of each of the first and second magnets is substantially constant from the first end to the second end.

9. The nozzle for the painting system according to claim 4, wherein
a longitudinal thickness of each of the first and second magnets is variable from the first end to the second end.

10. The nozzle for the painting system according to claim 9, wherein
the longitudinal thickness decreases from the first end to the second end.

11. The nozzle for the painting system according to claim 1, wherein
each of the first and second magnets includes a first portion and a second portion, the first portion extending substantially helically, and the second portion extending substantially longitudinally.

12. The nozzle for the painting system according to claim 11, wherein
the first portion is disposed upstream of the second portion.

13. A voltage-assisted painting system comprising:
a housing having a conduit configured to receive paint from an external source;
a power source; and
a nozzle disposed in the housing, the nozzle having an inlet that is fluidly connected to the conduit and configured to receive paint from the conduit, the nozzle having an outlet configured to dispense the paint, the nozzle including
a first electrode connected to the power source;
a second electrode connected to the power source;
a first magnet disposed between the first and second electrodes when viewed in a direction parallel to a longitudinal axis of the nozzle; and
a second magnet disposed between the first and second electrodes when viewed in the direction parallel to the longitudinal axis of the nozzle,
the first and second electrodes and the first and second magnets defining a passage through which the paint is configured to flow.

14. The voltage-assisted painting system according to claim 13, wherein
an air passage surrounds an outer surface of the nozzle at the nozzle outlet, the air passage being configured to supply air externally of the nozzle outlet.

15. The voltage-assisted painting system according to claim 13, wherein
a transducer is disposed adjacent the nozzle, the transducer being configured to emit an acoustic wave to the passage.

16. The voltage-assisted painting system according to claim 13, wherein
each of the first and second magnets extends substantially longitudinally from the nozzle inlet to the nozzle outlet.

17. The voltage-assisted painting system according to claim 16, wherein
each of the first and second magnets includes a first portion, a second portion and a third portion, the first and third portions being longitudinally aligned, the second portion being circumferentially offset from the first and third portions.

18. The voltage-assisted painting system according to claim 13, wherein
each of the first and second magnets extends helically from the nozzle inlet to the nozzle outlet.

19. The voltage-assisted painting system according to claim 18, wherein
each of the first and second magnets has a substantially constant pitch from a first end to a second end.

20. The voltage-assisted painting system according to claim 18, wherein
each of the first and second magnets has a variable pitch from a first end to a second end.
